(19) United States
(12) Patent Application Publication
(10) Pub. No.: US 2010/0062802 A1
(43) Pub. Date: Mar. 11, 2010

(54) METHOD DEVICE AND SYSTEM FOR RECEIVING A COMMUNICATION SIGNAL

(76) Inventor: Noam Amram, Kibbutz Meggldo (IL)

Correspondence Address: Professional Patent Solutions, P.O. BOX 654, HERZELIYA PITUACH, 46105, IL

(21) Appl. No.: 12/296,431

(22) PCT Filed: Apr. 10, 2007
(86) PCT No.: PCT/IL07/00442

§ 371 Date: Oct. 8, 2008

Related U.S. Application Data
(60) Provisional application No. 60/744,514, filed on Apr. 10, 2006.

(51) Int. Cl. H04M 1/00

(52) U.S. Cl. 455/556.1

(57) ABSTRACT

Disclosed are a method, device and system for enhancing reception of a communication signal in a wireless communication network. According to some embodiments of the present invention, a supplemental receiver transmits a communication augmentation signal to a mobile device. The supplemental receiver is also adapted to receive from the mobile device a signal including audio content.

### FIELD OF THE INVENTION

The present invention relates generally to the field of communication. More specifically, the present invention relates to a method, device and system for enhancing reception of a communication signal in a wireless communication network.

### BACKGROUND

Since the development of crude communication systems based on electrical signals, the world's appetite for more and more advanced forms of communication has continually increased. From wired cable networks over which operators would exchange messages using Morse-Code, to the broadband wireless networks of today, whenever technology has provided a means by which to communicate more information, people have found a use for that means, and have demanded more.

Modern communication networks are best characterized by features such as high bandwidth/data-rate, complex communication protocols, various transmissions medium, and various access means. Fiber optic networks span much of the world's surface, acting as long-haul networks for carrying tremendous amounts of data between distant points on the globe. Cable and other wire-based networks supplement coverage provided by fiber optic networks, where fiber networks have not yet been installed, and are still used as part of local area networks (“LAN”), for carrying data between points relatively close to one another. In addition to wire-based networks, wireless networks such as cellular networks (e.g. 2G, 3G, CDMA, WCDMA, WiFi, etc.) are used to supplement coverage for various devices (e.g. cell phone, wireless IP phone, wireless internet appliance, etc.) not connected to a fixed network connection. Wireless networks may act as complete local loop networks and may provide a complete wireless solution, where a communication device in an area may transmit and receive data from another device entirely across the wireless network.

With the proliferation of communication networks and the world's growing reliance upon them, proper performance is crucial. High data rates and stable communication parameters at low power consumption levels are highly desirable for communication devices. However, degradation of signal-to-noise ratio (“SNR”) as well as Bit energy to noise ratio (“Eb/No”) and interference ratios such as Carrier to-Interference (“C/I”) ratio occur to a signal carried along a transmission medium (e.g. coax, unshielded conductor, wave guide, open air or even optical fiber or RF over fiber). This degradation and interferences may occur in TDMA, CSMA, CDMA, EVDO, WCDMA and WiFi networks respectively. Signal attenuation and its resulting SNR degradation may limit bandwidth over a transmission medium.

Thus, strong and stable signals are needed for the proper operation of a communication device. In order to improve the power level of signals being transmitted over relatively long distances, and accordingly to augment the transmission distance and/or data rate, devices may utilize power amplifiers to boost transmission signal strength. In addition to the use of power amplifiers for the transmission of communication signals, receivers may use low noise amplifiers and variable gain amplifiers (“VGA's”) in order to boost and adjust the strength and/or amplitude of a received signal.

Wireless networks such as cellular networks are characterized by a multipath channel between the base station antennas and the mobile equipment (ME) antenna which introduce “fading” in the received signal power. The combination of attenuation, noise interference and “fading” is a substantial limitation for wireless network operators, mitigating their ability to provide high data-rate services such as Internet access and video phone services.

There exists a need in the field of wireless communications for a method, circuit/device and system for enhancing communication signal reception by a mobile communication device (e.g. cellular phone).

### SUMMARY OF THE INVENTION

According to some embodiments of the present invention, there may be provided a method, circuit/device and system for enhancing communication by a mobile communication device such as a cell-phone or smart-phone. According to some embodiments of the present invention, a communication signal may be received at two or more separate receivers, which two or more separate receivers may be functionally associated over a multi-purpose wireless data link. Data derived from the received communication signal may be transmitted to signal processing circuitry on a communication device over the multi-purpose wireless data link and the derived data may be used by the signal processing circuitry on the communication device in interpreting the received communication signal.

According to some embodiments of the present invention, there may be provided one or more supplemental receivers for facilitating diversity reception and combination of a communication signal associated with a primary communication device. Various types of communication augmentation signals may be produced on a supplemental receiver and transmitted to the communication device. Any communication augmentation technology, technique or methodology which is known today or to be devised in the future may be applicable to the present invention. For example, the type of augmentation signal which may be produced by the supplemental receiver and transmitted to the communication device may mitigate a fading channel by using channel coding or forward error correction (“FEC”) together with interleaving to achieve time diversity. Another method for overcoming the fading is by using multiple inputs multiple outputs (“MIMO”) antennas schemes which improve the capacity significantly by achieving spatial diversity, spatial multiplexing or beam-forming. In a MIMO scheme, in order to achieve spatial diversity the antennas may be positioned with a spatial distance from one to another, this distance reduces fades correlation between the antennas. The distance between the antennas relates to the wave length “Lambda” of the radio frequency (“RF”) signal. Typically the antennas should be separated with a distance greater then Lambda. One common way of receive diversity on a small wireless device is to use a polarization scheme where one antenna lies with a 90 degrees angle with respect to the other antenna. This method can improve the capacity in a limited way when compared to spatial diversity. Another way to achieve spatial diversity is called a cooperative diversity where different wireless devices cooperative with one another in order to improve the reception condition of one of them. In a receive diversity scheme such as two receiving antennas, each antenna is connected to a different receiver and the output of each receiver is combined together to improve the overall SNR.

According to some embodiments of the present invention, there may be provided a method, circuit/device and system for enhancing communication by a mobile communication device such as a cell-phone or smart-phone. There may be provided a supplemental receiver for facilitating beam-forming reception of a communication signal associated with a primary communication device.

According to some embodiments of the present invention, there may be provided a method, circuit/device and system for enhancing communication by a mobile communication device such as a cell-phone or smart-phone. There may be provided a supplemental receiver for facilitating spatial de-multiplexing of communication signals associated with a primary communication device.

According to some embodiments of the present invention, there may be provided a method, circuit/device and system for enhancing communication by a mobile communication device such as a cell-phone or smart-phone. There may be provided a supplemental repeater for amplifying a communication signal associated with a primary communication device.

Diversity reception and combination was describer in a book by D. G. Brennan, “Linear diversity combining techniques,” Proc. IRE, vol. 47, no. 1, pp. 1075-1102, June 1959. Beam-forming, spatial multiplexing, repeater based processing, and various techniques related to enhancing signal reception using multiple antennas and/or multiple receivers have been discussed in the following publications:
E. G. Larsson and P. Stoica, Space-Time Block Coding for Wireless Communications. Cambridge, UK: Cambridge University Press, May 2003. ISBN 0-521-82456-7. Chinese translation by Xi'an Jiaotong University Press, 2006, ISBN 7-5605-2175-4/TN.
E. G. Larsson, J. Li, and P. Stoica, “High-resolution nonparametric spectral analysis: theory and applications,” in High-resolution and robust signal processing (Y. Hua, A. B. Gershman,and Q. Cheng, eds.), New York, N.Y.: Marcel-Dekker, 2003. ISBN 0-8247-4752-6.
E. G. Larsson, “Model-averaged interference rejection combining,” IEEE Transactions on Communications. To appear.
Y. Sel'en and E. G. Larsson, “RAKE receiver for channels with a sparse impulse response,” IEEE Transactions on Wireless Communications. To appear.
E. G. Larsson and Y. Sel'en, “Linear regression with a sparse parameter vector,” IEEE Transactions on Signal Processing, February 2007.
N. Zhang, B. Vojcic, M. Souryal, and E. G. Larsson, “Exploiting multiuser diversity in reservation random access,” IEEE Transactions on Wireless Communications, September 2006.
E. G. Larsson and B. Vojcic, “Cooperative transmit diversity based on superposition modulation,” IEEE Communications Letters, September 2005.
M. Doroslova\ddot{}cki and E. G. Larsson, “Nonuniform linear antenna arrays minimizing Cram'er-Rao bounds for joint estimation of single source range and direction-of-arrival,” IEEE Proceedings on Radar, Sonar and Navigation, August 2005.
E. G. Larsson and Y. Cao, “Collaborative transmit diversity with adaptive radio resource and power allocation,” IEEE Communications Letters, June 2005.
S. Alty, A. Jakobsson, and E. G. Larsson, “Efficient implementation of the time-recursive Capon and APES spectral estimators,” IEEE Transactions on Circuits and Systems, March 2005.
E. G. Larsson, Y. Sel'en, and P. Stoica, “Adaptive equalization for frequency-selective channels of unknown length,” IEEE Transactions on Vehicular Technology, March 2005.
E. G. Larsson, “Multiuser detection with an unknown number of users,” IEEE Transactions on Signal Processing, February 2005.
D. Erdogmus, R. Yan, E. G. Larsson, J. C. Principe, and J. R. Fitzsimmons, “Image construction methods for phased array magnetic resonance imaging,” Journal of Magnetic Resonance Imaging, August 2004.
E. G. Larsson, “Improving the frame-error-rate of spatial multiplexing in block fading by randomly rotating the signal constellation,” IEEE Communications Letters, August 2004.
E. G. Larsson, “On the combination of spatial diversity and multiuser diversity,” IEEE Communications Letters, August 2004.
D. Erdogmus, E. G. Larsson, R. Yan, J. C. Principe, and J. R. Fitzsimmons, “Measuring the signal-to-noise-ratio in magnetic resonance imaging: A caveat,” Signal Processing, May 2004.
D. Erdogmus, E. G. Larsson, R. Yan, J. C. Principe, and J. R. Fitzsimmons, “Asymptotic SNR performance of some image combination techniques for phased-array MRI,” Signal Processing, May 2004.
E. G. Larsson and W.-H. Wong, “Nonuniform space-time codes for layered source coding, IEEE Transactions on Wireless Communications, May 2004.
G. Ganesan, P. Stoica, and E. G. Larsson, “Orthogonal space-time block codes with feedback,” Wireless Personal Communications, March 2004.
E. G. Larsson, “Cram'er-Rao bound analysis of distributed positioning in sensor networks,” IEEE Signal Processing Letters, March 2004.
E. G. Larsson, “Diversity and channel estimation errors,” IEEE Transactions on Communications, February 2004.
E. K. Larsson and E. G. Larsson, “The CRB for parameter estimation in irregularly sampled continuous-time ARMA systems,” IEEE Signal Processing Letters, February 2004.
E. G. Larsson and P. Stoica, “Mean square error optimality of orthogonal space-time block codes,” IEEE Signal Processing Letters, November 2003.
E. G. Larsson and J. Li, “Spectral analysis of periodically gapped data,” IEEE Transactions on Aerospace and Electronic Systems, July 2003.
E. G. Larsson, D. Erdogmus, R. Yan, J. C. Principe, and J. R. Fitzsimmons, “SNR-optimality of sum-of-squares reconstruction for phased-array magnetic resonance imaging,” Journal of Magnetic Resonance, July 2003.
W.-H. Wong and E. G. Larsson, “Orthogonal space-time block coding with antenna selection and power allocation,” IEE Electronic Letters, February 2003.
E. G. Larsson, P. Stoica, and J. Li, “Orthogonal space-time block codes: Maximum-likelihood detection for unknown channels and unstructured interference,” IEEE Transactions on Signal Processing, February 2003.
E. G. Larsson, “Unitary nonuniform space-time constellations for the broadcast channel,” IEEE Communications Letters, January 2003.
E. G. Larsson and E. K. Larsson, “The Cram'er-Rao bound for continuous-time autoregressive parameter estimation with irregular sampling,” Circuits, Systems and Signal Processing, 2002.
E. G. Larsson, P. Stoica, and J. Li, “Spectral estimation via adaptive filterbank methods: A unified analysis and a new algorithm,” Signal Processing, December 2002.
E. G. Larsson, G. Ganesan, P. Stoica, and W.-H. Wong, “On the performance of orthogonal space-time block coding with quantized feedback,” IEEE Communications Letters, November 2002.
E. G. Larsson, P. Stoica, and J. Li, “On a decoupled approach to adaptive signal separation using an antenna array,” IEEE Transactions on Vehicular Technology, November 2002.
E. G. Larsson, P. Stoica, and J. Li, “Amplitude spectrum estimation for two-dimensional gapped data,” IEEE Transactions on Signal Processing, June 2002.
E. G. Larsson, P. Stoica, and J. Li, “On maximum-likelihood detection and decoding for spacetime coding systems,” IEEE Transactions on Signal Processing, April 2002.
J. Liu, J. Li, and E. G. Larsson, “Differential space-time block code modulation for DS-CDMA systems,” EURASIP Journal on Applied Signal Processing, March 2002.
A. B. Gershman, P. Stoica, M. Pesavento, and E. G. Larsson, “Stochastic Cram'er-Rao bounds for direction estimation in unknown noise fields,” IEE Proceedings on Radar, Sonar and Navigation, February 2002.
X. Li, E. G. Larsson, J. Li, and M. Sheplak, “Phase-shift based time-delay estimators for proximity acoustic sensors,” IEEE Journal of Oceanic Engineering, January 2002.
E. G. Larsson and P. Stoica, “Fast implementation of two-dimensional APES and CAPON spectral estimators,” Multidimensional Systems and Signal Processing, January 2002.
P. Stoica and E. G. Larsson, “Comments on Linearization Method for Finding Cram'er-Rao Bounds in Signal Processing,” IEEE Transactions on Signal Processing, December 2001.
E. G. Larsson and J. Li, “Preamble design for multiple-antenna OFDM-based WLANs with null subcarriers,” IEEE Signal Processing Letters, November 2001.
E. G. Larsson, G. Liu, P. Stoica, and J. Li, “High-resolution SAR imaging with angular diversity,” IEEE Transactions on Aerospace and Electronic Systems, October 2001.
E. G. Larsson, G. Liu, J. Li, and G. B. Giannakis, “Joint symbol timing and channel estimation for OFDM based WLANs,” IEEE Communications Letters, vol. 5, pp. 325-327, August 2001.
J. Liu, J. Li, H. Li, and E. G. Larsson, “Differential space-code modulation for interference suppression,” IEEE Transactions on Signal Processing, vol. 49, pp. 1786-1795, August 2001.
E. G. Larsson, J. Liu, and J. Li, “Demodulation of space-time codes in the presence of interference,” IEE Electronic Letters, vol. 37, pp. 697-698, May 2001.
E. G. Larsson and P. Stoica, “High-resolution direction finding: the missing data case,” IEEE Transactions on Signal Processing, vol. 49, pp. 950-958, May 2001.
P. Stoica, E. G. Larsson, and A. B. Gershman, “The stochastic CRB for array processing: a textbook derivation,” IEEE Signal Processing Letters, vol. 8, pp. 148-150, May 2001.
P. Stoica, E. G. Larsson, and J. Li, “Adaptive filterbank approach to restoration and spectral analysis of gapped data,” The Astronomical Journal, vol. 120, pp. 2163-2173, October 2000.
M. N. Khormuji and E. G. Larsson, “Receiver design for wireless relay channels with regenerative relays,” in Proc. of Proc. of IEEE International Conference on Communications (ICC), June 2007. To appear.
Y. Sel'en and E. G. Larsson, “Empirical Bayes linear regression with unknown model order,” in Proc. of IEEE International Conference on Acoustics, Speech and Signal Processing (ICASSP), April 2007. To appear.
M. Mowl'er, E. G. Larsson, B. Lindmark, and B. Ottersten, “Methods and bounds for antenna array coupling matrix estimation,” in Proc. of IEEE International Conference on Acoustics, Speech and Signal Processing (ICASSP), April 2007. To appear.
M. Skoglund and E. G. Larsson, “Optimal modulation for known interference,” in Proc. of IEEE International Conference on Acoustics, Speech and Signal Processing (ICASSP), April 2007. To appear.
M. N. Khormuji and E. G. Larsson, “Improving collaborative transmit diversity by using constellation rearrangement,” in Proc. of Wireless Communications and Networking Conference (WCNC), March 2007. To appear.
Y. Sel'en and E. G. Larsson, “Parameter estimation and order selection for linear regression problems,” in Proc. of European Signal Processing Conference (EUSIPCO), September 2006.
E. G. Larsson and Y. Sel'en, “Linear regression with a sparse parameter vector,” in Proc. Of IEEE International Conference on Acoustics, Speech and Signal Processing (ICASSP), May 2006.
J. Du, E. G. Larsson, and M. Skoglund, “Costa precoding in one dimension,” in Proc. of IEEE International Conference on Acoustics, Speech and Signal Processing (ICASSP), May 2006.
T. T. Kim, M. Bengtsson, E. G. Larsson, and M. Skoglund, “Combining short-term and longterm channel state information over correlated MIMO channels,” in Proc. of IEEE International Conference on Acoustics, Speech and Signal Processing (ICASSP), May 2006.
Y. Sel'en and E. G. Larsson, “Model-averaged RAKE receivers for direct-sequence spreadspectrum systems,” in Proc. of Asilomar Conference on Signals, Systems and Computers, (Pacific Grove, Calif.), November 2005.
E. G. Larsson and B. R. Vojcic, “Cooperative transmit diversity via superposition coding,” in Proc. of EUROCON 2005, (Belgrade, Serbia & Montenegro), November 2005. Invited paper.
B. Peric, M. Souryal, E. G. Larsson, and B. Vojcic, “Soft-decision metrics for turbo-coded FH M-FSK ad hoc packet radio networks,” in Proc. of IEEE Vehicular Technology Conference, (Stockholm, Sweden), May 2005.
Y. Cao, E. G. Larsson, and B. Vojcic, “Cooperative diversity transmission versus macrodiversity in cellular networks,” in Proc. of the Conference on Information Sciences and Systems (CISS), (Baltimore, Md.), March 2005.
E. G. Larsson, “Robust structured interference rejection combining,” in Proc. of IEEEWireless Communications and Networking Conference (WCNC), (New Orleans, La.), March 2005.
M. Souryal, E. G. Larsson, B. Peric, and B. Vojcic, “Soft-decision metrics for coded orthogonal signaling in symmetric alpha-stable noise,” in Proc. of IEEE International Conference on Acoustics, Speech and Signal Processing (ICASSP), (Philadelphia, Pa.), March 2005.
Y. Sel'en, E. G. Larsson, P. Stoica, and N. Sandgren, “A model averaging approach for equalizing sparse communication channels,” in Proc. of Asilomar Conference on Signals, Systems and Computers, (Pacific Grove, Calif.), November 2004.
E. G. Larsson, “Constellation randomization (CoRa) for outage performance improvement on MIMO channels,” in Proc. of IEEE Global Telecommunications Conference (GLOBECOM), (Dallas, Tex.), December 2004.
E. G. Larsson, Y. Sel'en, and P. Stoica, “Adaptive equalization for frequency-selective channels of unknown length,” in Proc. of IEEE Global Telecommunications Conference (GLOBECOM), (Dallas, Tex.), December 2004.
S. Alty, A. Jakobsson, and E. G. Larsson, “Efficient implementation of the time-recursive Capon and APES spectral estimators,” in Proc. of European Signal Processing Conference, September 2004.
D. Erdogmus, R. Yan, E. G. Larsson, J. C. Principe, and J. R. Fitzsimmons, “Mixture of competitive linear models for phased-array magnetic resonance imaging,” in Proc. of IEEE International Conference on Acoustics, Speech and Signal Processing (ICASSP), (Montreal, Quebec, Canada), May 2004.
E. G. Larsson and M. Doroslova\ddot{}cki, “Design of a nonuniform array for joint direction-of arrival and range estimation,” in Proc. of URSI International Symposium on Electromagnetic Theory, (Pisa, Italy), May 2004. Invited paper.
E. G. Larsson, “Multiuser detection with an unknown number of users,” in Proc. of the Conference on Information Sciences and Systems (CISS), (Princeton, N.J.), pp. 1078-1082, March 2004.
E. G. Larsson, “Semi-structured interference suppression for orthogonal frequency division multiplexing,” in Proc. of IEEE International Symposium on Signal Processing and Information Technology, (Darmstadt, Germany), December 2003.
E. K. Larsson and E. G. Larsson, “The CRB for parameter estimation in irregularly sampled continuous-time ARMA systems,” in Proc. of IEEE International Symposium on Signal Processing and Information Technology, (Darmstadt, Germany), December 2003.
E. G. Larsson, “Distributed positioning in ad hoc networks: A Cram'er-Rao bound analysis,” in Proc. of IEEE Vehicular Technology Conference (VTC), (Orlando, Fla.), October 2003.
E. G. Larsson and P. Stoica, “Mean square error optimality of orthogonal space-time block codes,” in Proc. of IEEE International Conference on Communications (ICC), (Anchorage, Ak.), May 2003.
R. Yan, D. Erdogmus, E. G. Larsson, J. C. Principe, and J. R. Fitzsimmons, “Image combination for high-field phased-array MRI,” in Proc. of IEEE International Conference on Acoustics, Speech and Signal Processing (ICASSP), (Hong Kong), April 2003.
G. Ganesan, P. Stoica, and E. G. Larsson, “Diagonally weighted orthogonal space-time block codes,” in Proc. of Asilomar Conference on Signals, Systems and Computers, (Pacific Grove, Calif.), pp. 1147-1151, November 2002.
E. G. Larsson, P. Stoica, E. Lindskog, and J. Li, “Space-time block coding for frequency selective channels,” in Proc. of IEEE International Conference on Acoustics, Speech and Signal Processing (ICASSP), (Orlando, Fla.), pp. 2405-2408, May 2002.
E. G. Larsson and J. Li, “SAR image construction from periodically gapped phase-history data,” in Proc. of SPIE Aerosense Conference, (Orlando, Fla.), pp. 154-165, April 2002.
E. G. Larsson, P. Stoica, and J. Li, “Space-time block codes: ML detection for unknown channels and unstructured interference,” in Proc. of Asilomar Conference on Signals, Systems and Computers, (Pacific Grove, Calif.), pp. 916-920, November 2001.
E. G. Larsson, P. Stoica, and J. Li, “ML detection and decoding of space-time codes,” in Proc. of Asilomar Conference on Signals, Systems and Computers, (Pacific Grove, Calif.), pp. 1435-1439, November 2001. Invited paper.
E. G. Larsson, P. Stoica, and J. Li, “SAR image construction from gapped phase-history data,” in Proc. of International Conference on Image Processing, (Thessaloniki, Greece), pp. 608-611, October 2001.
P. ° Ahgren and E. G. Larsson, “Echo-cancellation in mono and stereo using the conjugate gradient method,” in Proc. of the IEEE/EURASIP International Workshop on Acoustic Echo and Noise Control, (Darmstadt, Germany), pp. 115-119, September 2001.
E. G. Larsson, G. Liu, J. Li, and G. B. Giannakis, “An algorithm for joint symbol timing and channel estimation for OFDM systems,” in Proc. of IEEE Workshop on Statistical Signal Processing, (Orchid Country Club, Singapore), pp. 393-396, August 2001. Invited paper.
R. Abrahamsson, E. G. Larsson, J. Li, J. Habersat, G. Maksymonko, and M. Bradley, “Elimination of leakage and ground-bounce in ground-penetrating radar data,” in Proc. of IEEE Workshop on Statistical Signal Processing, (Orchid Country Club, Singapore), pp. 150-153, August 2001. Invited paper.
A. B. Gershman, M. Pesavento, P. Stoica, and E. G. Larsson, “The stochastic CRB for array processing in unknown noise fields,” in Proc. of IEEE International Conference on Acoustics, Speech and Signal Processing (ICASSP), vol. 5, (Salt Lake City, Utah), pp. 2898-2992, May 2001.
E. K. Larsson and E. G. Larsson, “Cram'er-Rao bounds for continuous-time AR parameter estimation with irregular sampling,” in Proc. of IEEE International Conference on Acoustics, Speech and Signal Processing (ICASSP), vol. 5, (Salt Lake City, Utah), pp. 3097-3100, May 2001.
E. G. Larsson and P. Stoica, “Fast implementation of two-dimensional APES and CAPON spectral estimators,” in Proc. of IEEE International Conference on Acoustics, Speech and Signal Processing (ICASSP), vol. 5, (Salt Lake City, Utah), pp. 3069-3072, May 2001.
E. G. Larsson, G. Liu, J. Li, P. Stoica, and R. Williams, “Spectral estimation of gapped data and SAR imaging with angular diversity,” in Proc. of SPIE Aerosense Conference, (Orlando, Fla.), April 2001.
E. G. Larsson, R. Abrahamsson, J. Li, K. Gu, M. Bradley, J. Habersat, and G. Maksymonko, “Reducing the ground-bounce effects for mine detection with a ground-penetrating radar,” in Proc. of the UXO/Countermine Forum, (New Orleans, La.), April 2001.
E. G. Larsson, J. Li, J. Habersat, G. Maksymonko, and M. Bradley, “Removal of surface returns in ground-penetrating radar data,” in Proc. of SPIE Aerosense Conference, (Orlando, Fla.), April 2001.
J. Liu, E. G. Larsson, J. Li, and H. Li, “High-rate differential space-code modulation for interference suppression,” in Proc. of IEEE Signal Processing Workshop on Signal Processing Advances in Wireless Communications, (Taoyuan, Taiwan), pp. 283-286, March 2001.
E. G. Larsson, P. Stoica, and J. Li, “Spectral analysis of gapped data,” in Proc. of Asilomar Conference on Signals, Systems and Computers, vol. 1, (Pacific Grove, Calif.), pp. 207-211, October 2000.
E. G. Larsson and P. Stoica, “Direction-of-arrival estimation from incomplete data,” in Proc. Of IEEE International Conference on Acoustics, Speech and Signal Processing (ICASSP), vol. 5, (Istanbul, Turkey), pp. 3081-3084, June 2000.
D. Bladsj\ddot{}o, A. Furusk\ddot{}ar, S. J\ddot{}averbring, and E. G. Larsson, “Interference cancellation using antenna diversity for EDGE—enhanced data rates in GSM and TDMA/136,” in Proc. of IEEE Vehicular Technology Conference, vol. 4, (Amsterdam, The Netherlands), pp. 1956-1960, September 1999.
S. Fischer, H. Koorapaty, E. G. Larsson, and A. Kangas, “System performance evaluation of mobile positioning systems,” in Proc. of IEEE Vehicular Technology Conference, vol. 3, (Houston, Tex.), pp. 1962-1966, May 1999.
S. Fischer, H. Grubeck, A. Kangas, H. Koorapaty, E. G. Larsson, and P. Lundqvist, “Time-of arrival estimation of narrowband TDMA signals for communications,” in Proc. of IEEE International Symposium on Personal, Indoor and Mobile Radio Communication, vol. 1, (Boston, Mass.), pp. 451-455, September 1998.
D. Bloomquist, M. McVay, E. G. Larsson, and C. Dumas, “Autonomous highway traffic modules,” U.S. Pat. No. 6,900,740 (granted on May 31, 2005).
E. G. Larsson, A. Kangas, and S. Fischer, “Efficient determination of time of arrival of radio communication bursts,” U.S. Pat. No. 6,529,708 (granted on Mar. 4, 2003).
E. G. Larsson, A. Kangas, and S. Fischer, “Identifying starting time for making time of arrival measurements,” U.S. Pat. No. 6,522,887 (granted on Feb. 18, 2003).
A. Kangas, E. G. Larsson, S. Fischer, and P. Lundqvist, “Downlink observed time difference measurements,” U.S. Pat. No. 6,490,454 (granted on Dec. 3, 2002).
A. Kangas, S. Fischer, P. Lundqvist, and E. G. Larsson, “Making time of arrival measurements,” U.S. Pat. No. 6,470,185 (granted on Oct. 22, 2002).
A. Kangas, E. G. Larsson, S. Fischer, P. Lundqvist, and M. Cedervall, “Downlink observed time difference measurements,” U.S. Pat. No. 6,356,763 (granted on Mar. 12, 2002).
S. Fischer, A. Kangas, P. Lundqvist, and E. G. Larsson, “Methods and arrangements for locating a mobile telecommunications station,” U.S. Pat. No. 6,295,455 (granted on Sep. 25, 2001).
E. G. Larsson, S. Fischer, and A. Kangas, “Selection of location measurement units for determining the position of a mobile communication station,” U.S. Pat. No. 6,282,427 (granted on Aug. 28, 2001).
A. Kangas, E. G. Larsson, and S. Fischer, “Use of global positioning system in locating a radio transmitter,” U.S. Pat. No. 6,266,012 (granted on Jul. 24, 2001).
A. Sendonaris, E. Erkip, and B. Aazhang, “User cooperation diversity: Part I System description,” IEEE Trans. Comm., vol. 51, pp. 1927-1938, November 2003.
A. Sendonaris, E. Erkip, and B. Aazhang, “User cooperation diversity: Part I Implementation aspects and performance analysis,” IEEE Trans. Comm., vol. 51, pp. 1939-1948, November 2003.
J. N. Laneman, D. N. C. Tse, and G. W. Wornell, “Cooperative diversity in wireless networks: Efficient protocols and outage behavior,” IEEE Trans. Inf. Theory, vol. 50, pp. 3062-3080, December 2004.
E. G. van der Meulen, “A survey of multi-way channels in Inf. Theory: 1961-1977,” IEEE Trans. Inf. Theory, vol. 23, pp. 1-37, January 1977.
T. M. Cover and A. El Carnal, “Capacity theorems for the relay channel,” IEEE Trans. Inf. Theory, vol. 25, pp. 572-584, 1979.
M. Gastpar and M. Vetterli, “On the capacity of wireless networks: the relay case,” in Proc. IEEE INFOCOM 2002, New York, N.Y., June 2002, pp. 1577-1586.
G. Kramer, M. Gastpar, and P. Gupta, “Cooperative strategies and capacity theorems for relay networks,” IEEE Trans. on Inf. Theory, vol. 51, pp. 3037-3063, September 2005.
J. N. Laneman and G. W. Wornell, “Distributed space-time-coded protocols for exploiting cooperative diversity in wireless networks,” IEEE Trans. Inf. Theory, vol. 49, pp. 2415-2425, 2003.
A. Ribeiro, X. Cai, and G. B. Giannakis, “Symbol error probabilities for general cooperative link,” to appear in the IEEE Trans. Wireless Communications, 2005.
W. Mo and Z. Wang, “Average symbol error probability and outage probability analysis for general cooperative diversity system at high signal to noise ratio,” in Proc. CISS, Princeton, N.J., March 2004.
D. Chen and J. N. Laneman, “Modulation and demodulation for cooperative diversity in wireless systems,” IEEE Trans. Wireless Comm., to appear.
R. S. Blum, “Distributed detection for diversity reception of fading signals in noise,” IEEE Trans. Inf. Theory, vol. 45, pp. 158-164, January 1999.
J. Proakis, Digital Communications, McGraw Hill, 1995.
Monzingo and Miller, Introduction to Adaptive Arrays”, Wiley, 1980.
Winters, J. “Optimum Combining in Digital Mobile Radio with Cochannel Interference”, Selected Areas in Communications, IEEE Journal on, Volume: 2, Issue: 4, July 1984, Pages: 528-539
J. C. Liberti. and T. S. Rappaport, Smart Antennas for Wireless Communications: IS-95 and Third Generation CDMA Applications, Prentice Hall, Upper Saddle River, N.J., 1999.
Ylitalo, J.; Tiirola, E.; “Performance evaluation of different antenna array approaches for 3G CDMA uplink”, Vehicular Technology Conference Proceedings, 2000. VTC 2000-Spring Tokyo. 2000 IEEE 51st, Volume: 2, 15-18 May 2000, Pages: 883-887 vol. 2
Foschini, “Layered space-time architecture for wireless communication in a fading environment when using multi-element antennas,”Bell Labs Tech. J, vol. 1, no. 2, pp. 41-59, 1996.
Foschini, G. D. Golden, R. A. Valenzuela, and P. W. Wolniansky, “Simplified processing for high spectral efficiency wireless communication employing multi-element arrays,”IEEE J. Select. Areas Commun., vol. 17, no. 11, pp. 1841-1852, November 1999.
Golden, C. J. Foschini, R. A. Valenzuela, and P. W. Wolniansky, “Detection algorithm and initial laboratory results using V-BLAST space-time communication architecture,”Electronics Letters, vol. 35, -no. 1, pp. 14-16, January 1999.
Hochwald and S. ten Brink, “Achieving near-capacity on a multiple-antenna channel,”IEEE Trans. Commun., vol. 51, no. 3, pp. 389-399, March 2003.
Vucetic & J. Yuan, Space-Time Coding. John Wiley and Sons, 2003. ISBN 0-470-84757-3
Wolniansky, G. J. Foschini, G. D. Golden, and R. A. Valenzuela, “V-BLAST: An architecture for realizing very high data rates over the rich-scattering wireless channel,”in International Symposium on Signals, Systems, and Electronics (ISSSE), 1998, pp. 295-300.
Zheng and D. N. C. Tse, “Diversity and multiplexing: A fundamental tradeoff in multiple-antenna channels,”IEEE Trans. Inform. Theory, vol. 49, no. 5, pp. 1073-1096, May 2003.

Each of the above cited publications is hereby incorporated by reference in its entirety. Any diversity method, beam-forming, spatial multiplexing and repeater technique or technology known today or to be devised in the future is applicable to the present invention.

According to some embodiments of the present invention, the supplemental receiver may include a first wireless (e.g. Radio Frequency) receiver circuitry corresponding to receiver circuitry on a communication device with which the supplement receiver is to operate. The first receiver circuitry may be adapted to tune into and receive a communication signal intended for the communication device with which the supplement receiver is to operate. For example, if the communication device is a mobile smart-phone receiving a communication signal containing a video-call or streaming video, the first receiver circuitry on the supplemental receiver may be adapted to concurrently receive the same communication signal as the communication device.

According to some embodiment of the present invention, the supplemental receiver's first receiver circuitry may be suitable to receive communication signals associated with the following wireless communication standards TDMA, CSMA, CDMA, EVDO, WCDMA, UMTS, WiFi and WiMax. It should be clear to one of ordinary skill in the art, however, that the first receiver circuitry is not limited to the above listed set of wireless communication standards, but may be suited to receive communication signals according to any wireless communication standard known today or to be devised in the future for use with communication devices.

According to some embodiment of the present invention, the supplemental receiver may include first transmitter circuitry adapted to transmit to the communication device an augmentation signal derived from the communication signal received by the first receiver circuitry. The supplemental receiver may also include a second receiver circuitry adapted to receive a signal including audio content from the communication device. The second receiver circuitry may also be adapted to receive from the communication device control signaling for the first receiver circuitry.

According to further embodiments of the present invention, the supplemental receiver may include a speaker and a microphone, and the transmitter circuitry may be adapted to transmit to the communication device a signal including audio content acquired by the microphone. A signal including audio content received by the second receiver circuitry from the communication device may be directed to the speaker.

According to some embodiments of the present invention, the second receiver circuitry may be adapted to receive from the communication device control signaling adapted to adjust the operation of the first receiver circuitry and signal characterization circuitry functionally associated with the first receiver circuitry. The signal characterization circuitry may be adapted to derive from the received communication signal an augmentation signal. The characterization circuitry may be adapted to produce an augmentation signal suitable for diversity reception processing by the mobile device. The characterization circuitry may be adapted to produce an augmentation signal suitable for beam forming processing. The characterization circuitry may be adapted to produce an augmentation signal suitable for special de-multiplexing processing. The characterization circuitry may be adapted to substantially repeat the communication signal received by the first receiver circuitry. Operation of the characterization circuitry may be regulated by the mobile device via control signaling transmitted to the supplemental receiver.

According to some embodiments of the present invention, the mobile communication device may include first receiver circuitry adapted to receive a communication augmentation signal from the supplemental receiver. The communication device may also include transmitter circuitry adapted to transmit a signal including audio content to the supplemental receiver. The mobile communication device may also include second receiver circuitry adapted to receive from the supplemental receiver a communication augmentation signal and a signal including audio content from a microphone functionally associated with the supplemental receiver.

According to some embodiments of the present invention, the mobile device transmitter circuitry may also be adapted to transmit control signaling to the supplemental receiver.

According to some embodiments of the present invention, the communication device second receiver circuitry may be adapted to receive a communication augmentation signal suitable for diversity reception processing. The communication device may include communication augmentation signal processing circuitry adapted to perform diversity reception processing on a communication signal received by the communication device and using the augmentation signal received from the supplemental receiver.

According to some embodiments of the present invention, the communication device second receiver circuitry may be adapted to receive a communication augmentation signal suitable for beam forming processing. The communication device may include communication augmentation signal processing circuitry adapted to perform beam forming processing on a communication signal received by the communication device and using the augmentation signal received from the supplemental receiver.

According to some embodiments of the present invention, the communication device second receiver circuitry may be adapted to receive a communication augmentation signal suitable for spatial de-multiplexing processing. The device may include communication augmentation signal processing circuitry adapted to perform spatial de-multiplexing processing on a communication signal received by the communication device and using the augmentation signal received from the supplemental receiver.

According to some embodiments of the present invention, the communication device second receiver circuitry may be adapted to receive a communication augmentation signal suitable for repeater signal processing. The communication device may include communication augmentation signal processing circuitry adapted to perform repeater based processing on a communication signal received by the communication device and using the augmentation signal received from the supplemental receiver.

According to some embodiments of the present invention, the second receiver circuitry on the mobile communication device and on the supplemental receiver may comply with any mid-range wireless communication standards, for example Bluetooth, WiFi, Irda, ect. Any such wireless communication technology, standard or methodology, known today or to be devised in the future, may be applicable to some embodiments of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows block diagrams of a mobile communication device and a supplemental receiver according to some embodiments of the present invention;

FIG. 2 shows a flow chart including the steps of an exemplary method of deriving a communication augmentation signal using a frame by frame handling process which may be executed by a supplemental receiver according to some embodiments of the present invention;

FIG. 3 shows a flow chart including the steps of an exemplary method of deriving a communication augmentation signal using a symbol by symbol handling process which may be executed by a supplemental receiver according to some embodiments of the present invention;

FIG. 4 shows a flow chart including the steps of an exemplary method of generating a repeater based communication augmentation signal which may be executed by a supplemental receiver according to some embodiments of the present invention;

FIG. 5 shows a flow chart including the steps of an exemplary method of producing a regenerated repeater based communication augmentation signal which may be executed by a supplemental receiver according to some embodiments of the present invention;

FIG. 6 shows a flow chart including the steps of an exemplary method of deriving a communication augmentation signal which may be used for a maximum ratio combining process according to some embodiments of the present invention;

FIG. 7 shows a flow chart including the steps of an exemplary method of spatial de-multiplexing which may be executed by a communication device receiving a communication augmentation signal according to some embodiments of the present invention; and

FIG. 8 shows a flow chart including the steps of an exemplary method of beam forming which may be executed by a communication device receiving a communication augmentation signal according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention.

However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

According to some embodiments of the present invention, there may be provided a method, circuit/device and system for enhancing communication by a mobile communication device such as a cell-phone or smart-phone. According to some embodiments of the present invention, a communication signal may be received at two or more separate receivers, which two or more separate receivers may be functionally associated over a multi-purpose wireless data link. Data derived from the received communication signal may be transmitted to signal processing circuitry on a communication device over the multi-purpose wireless data link and the derived data may be used by the signal processing circuitry on the communication device in interpreting the received communication signal.

According to some embodiments of the present invention, there may be provided one or more supplemental receivers for facilitating diversity reception and combination of a communication signal associated with a primary communication device. Various types of communication augmentation signals may be produced on a supplemental receiver and transmitted to the communication device. Any communication augmentation technology, technique or methodology which is known today or to be devised in the future may be applicable to the present invention. For example, the type of augmentation signal which may be produced by the supplemental receiver and transmitted to the communication device may mitigate a fading channel by using channel coding or forward error correction (“FEC”) together with interleaving to achieve time diversity. Another method for overcoming the fading is by using multiple inputs multiple outputs (“MIMO”) antennas schemes which improve the capacity significantly by achieving spatial diversity, spatial multiplexing or beam-forming. In a MIMO scheme, in order to achieve spatial diversity the antennas may be positioned with a spatial distance from one to another, this distance reduces fades correlation between the antennas. The distance between the antennas relates to the wave length “Lambda” of the radio frequency (“RF”) signal. Typically the antennas should be separated with a distance greater then Lambda. One common way of receive diversity on a small wireless device is to use a polarization scheme where one antenna lies with a 90 degrees angle with respect to the other antenna. This method can improve the capacity in a limited way when compared to spatial diversity. Another way to achieve spatial diversity is called a cooperative diversity where different wireless devices cooperative with one another in order to improve the reception condition of one of them. In a receive diversity scheme such as two receiving antennas, each antenna is connected to a different receiver and the output of each receiver is combined together to improve the overall SNR.

According to some embodiments of the present invention, there may be provided a method, circuit/device and system for enhancing communication by a mobile communication device such as a cell-phone or smart-phone. There may be provided a supplemental receiver for facilitating beam-forming reception of a communication signal associated with a primary communication device.

According to some embodiments of the present invention, there may be provided a method, circuit/device and system for enhancing communication by a mobile communication device such as a cell-phone or smart-phone. There may be provided a supplemental receiver for facilitating spatial de-multiplexing of communication signals associated with a primary communication device.

According to some embodiments of the present invention, there may be provided a method, circuit/device and system for enhancing communication by a mobile communication device such as a cell-phone or smart-phone. There may be provided a supplemental repeater for amplifying a communication signal associated with a primary communication device.

According to some embodiments of the present invention, the supplemental receiver may include a first wireless (e.g. Radio Frequency) receiver circuitry corresponding to receiver circuitry on a communication device with which the supplement receiver is to operate. The first receiver circuitry may be adapted to tune into and receive a communication signal intended for the communication device with which the supplement receiver is to operate. For example, if the communication device is a mobile smart-phone receiving a communication signal containing a video-call or streaming video, the first receiver circuitry on the supplemental receiver may be adapted to concurrently receive the same communication signal as the communication device.

According to some embodiment of the present invention, the supplemental receiver's first receiver circuitry may be suitable to receive communication signals associated with the following wireless communication standards TDMA, CSMA, CDMA, EVDO, WCDMA, UMTS, WiFi and WiMax. It should be clear to one of ordinary skill in the art, however, that the first receiver circuitry is not limited to the above listed set of wireless communication standards, but may be suited to receive communication signals according to any wireless communication standard known today or to be devised in the future for use with communication devices.

According to some embodiment of the present invention, the supplemental receiver may include first transmitter circuitry adapted to transmit to the communication device an augmentation signal derived from the communication signal received by the first receiver circuitry. The supplemental receiver may also include a second receiver circuitry adapted to receive a signal including audio content from the communication device. The second receiver circuitry may also be adapted to receive from the communication device control signaling for the first receiver circuitry.

According to further embodiments of the present invention, the supplemental receiver may include a speaker and a microphone, and the transmitter circuitry may be adapted to transmit to the communication device a signal including audio content acquired by the microphone. A signal including audio content received by the second receiver circuitry from the communication device may be directed to the speaker.

According to some embodiments of the present invention, the second receiver circuitry may be adapted to receive from the communication device control signaling adapted to adjust the operation of the first receiver circuitry and signal characterization circuitry functionally associated with the first receiver circuitry. The signal characterization circuitry may be adapted to derive from the received communication signal an augmentation signal. The characterization circuitry may be adapted to produce an augmentation signal suitable for diversity reception processing by the mobile device. The characterization circuitry may be adapted to produce an augmentation signal suitable for beam forming processing. The characterization circuitry may be adapted to produce an augmentation signal suitable for special de-multiplexing processing. The characterization circuitry may be adapted to substantially repeat the communication signal received by the first receiver circuitry. Operation of the characterization circuitry may be regulated by the mobile device via control signaling transmitted to the supplemental receiver.

According to some embodiments of the present invention, the mobile communication device may include first receiver circuitry adapted to receive a communication augmentation signal from the supplemental receiver. The communication device may also include transmitter circuitry adapted to transmit a signal including audio content to the supplemental receiver. The mobile communication device may also include second receiver circuitry adapted to receive from the supplemental receiver a communication augmentation signal and a signal including audio content from a microphone functionally associated with the supplemental receiver.

According to some embodiments of the present invention, the mobile device transmitter circuitry may also be adapted to transmit control signaling to the supplemental receiver.

According to some embodiments of the present invention, the communication device second receiver circuitry may be adapted to receive a communication augmentation signal suitable for diversity reception processing. The communication device may include communication augmentation signal processing circuitry adapted to perform diversity reception processing on a communication signal received by the communication device and using the augmentation signal received from the supplemental receiver.

According to some embodiments of the present invention, the communication device second receiver circuitry may be adapted to receive a communication augmentation signal suitable for beam forming processing. The communication device may include communication augmentation signal processing circuitry adapted to perform beam forming processing on a communication signal received by the communication device and using the augmentation signal received from the supplemental receiver.

According to some embodiments of the present invention, the communication device second receiver circuitry may be adapted to receive a communication augmentation signal suitable for spatial de-multiplexing processing. The device may include communication augmentation signal processing circuitry adapted to perform spatial de-multiplexing processing on a communication signal received by the communication device and using the augmentation signal received from the supplemental receiver.

According to some embodiments of the present invention, the communication device second receiver circuitry may be adapted to receive a communication augmentation signal suitable for repeater signal processing. The communication device may include communication augmentation signal processing circuitry adapted to perform repeater based processing on a communication signal received by the communication device and using the augmentation signal received from the supplemental receiver.

According to some embodiments of the present invention, the second receiver circuitry on the mobile communication device and on the supplemental receiver may comply with any mid-range wireless communication standards, for example Bluetooth, WiFi, Irda, ect. Any such wireless communication technology, standard or methodology, known today or to be devised in the future, may be applicable to some embodiments of the present invention. According to further embodiments of the present invention, the supplemental receiver may also include an audio unit having a microphone and/or a speaker. The supplemental receiver may also be a wireless audio input/out system for the communication device (e.g. a Bluetooth headset or audio gateway such as those sold by Nokia, Motorola, Jabra and others).

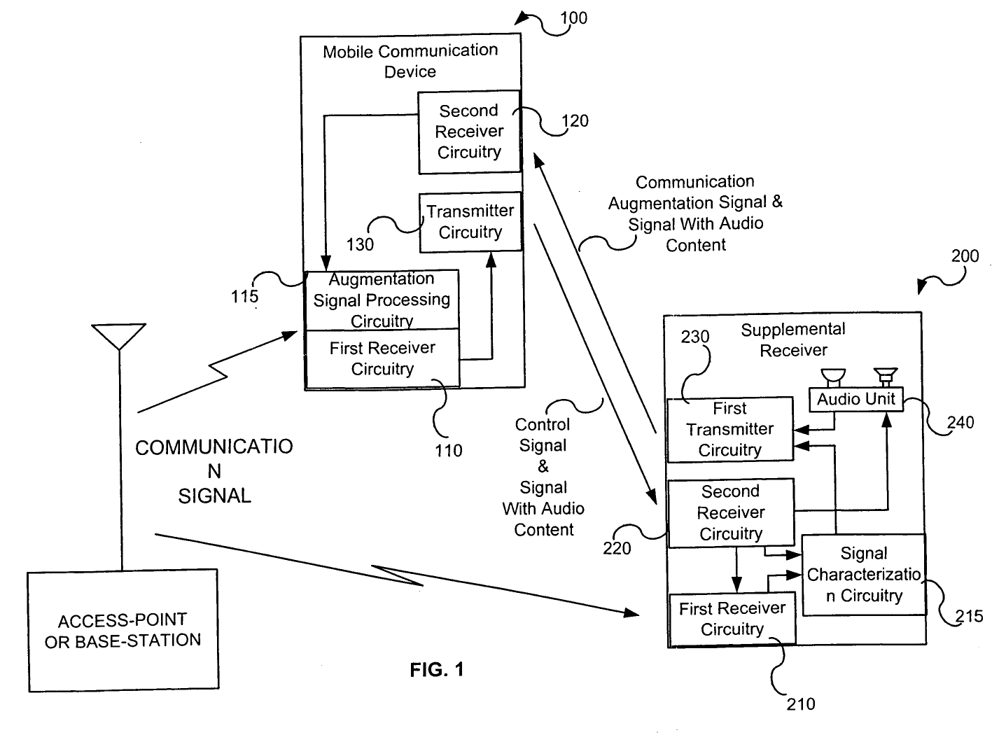

Turning now to FIG. 1, there are shown block diagrams of a communication device 100 and a supplemental receiver 200 according to some embodiments of the present invention. The supplemental receiver 200 and the communication device may each include first receiver circuitry (110 and 210, respectively) adapted to receive a communication signal. The mobile device 200 may transmit control signaling to the supplemental receiver via transmitter circuitry 130, which transmitter circuitry may also be used by the communication device to transmit an audio bearing signal.

Second receiver circuitry 220 on the supplemental receiver may receiver both control signaling and audio bearing signals from the communication device 100. Audio bearing signals may be directed to the audio unit 240 on the supplemental receiver, which audio unit may include a speaker. Control signaling received by the supplemental receiver 200 may be applied to the supplemental receiver's first receiver circuitry 210 in order to coordinate first receiver circuitry's 210 reception of a communication signal that first receiver circuitry 110 on the communication device is receiving or attempting to receive. The control signaling may also be applied to the signal characterization circuitry 215 in order to configure the circuitry to derive from the communication signal received by the first receiver circuitry 210 data suitable for augmenting reception/interpretation/decoding of the communication signal received by the first receiver circuitry 110 on the communication device 100.

Either data derived from the communication signal received at the first receiver circuitry 210 or a copy, complete or partial, of the communication signal received at the first receiver circuitry 210 may be transmitted to the communication device 100 as part of a communication augmentation signal via first transmitter circuitry 230 on the supplemental receiver 200. The communication augmentation signal may be received by the communication device 100 through its second receiver circuitry 120 and processed via augmentation signal processing circuitry 115 functionally associated with the first receiver circuitry 110 on the communication device 100.

The transmitter circuitry 230 on the supplemental receiver may also be used to transmit an audio bearing signal (i.e. audio acquired by a microphone connected to the audio unit 240) to the communication device 100, which audio bearing signal may also be received by the communication device 100 via second receiver circuitry 120. According to some embodiments of the present invention, The supplemental receiver may also be a wireless audio input/out system for the communication device (e.g. a Bluetooth headset or audio gateway such as those sold by Nokia, Motorola, Jabra and others).

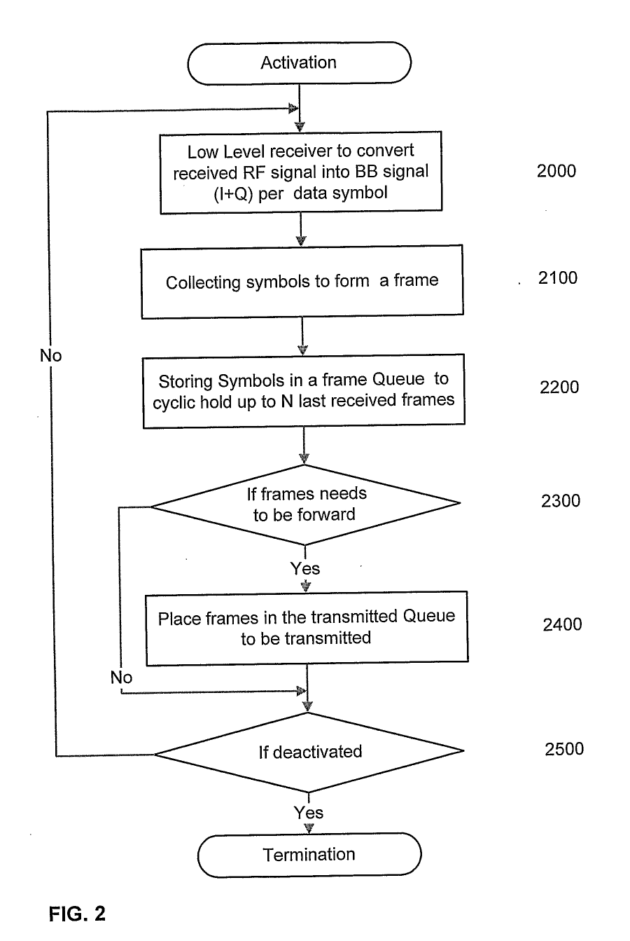

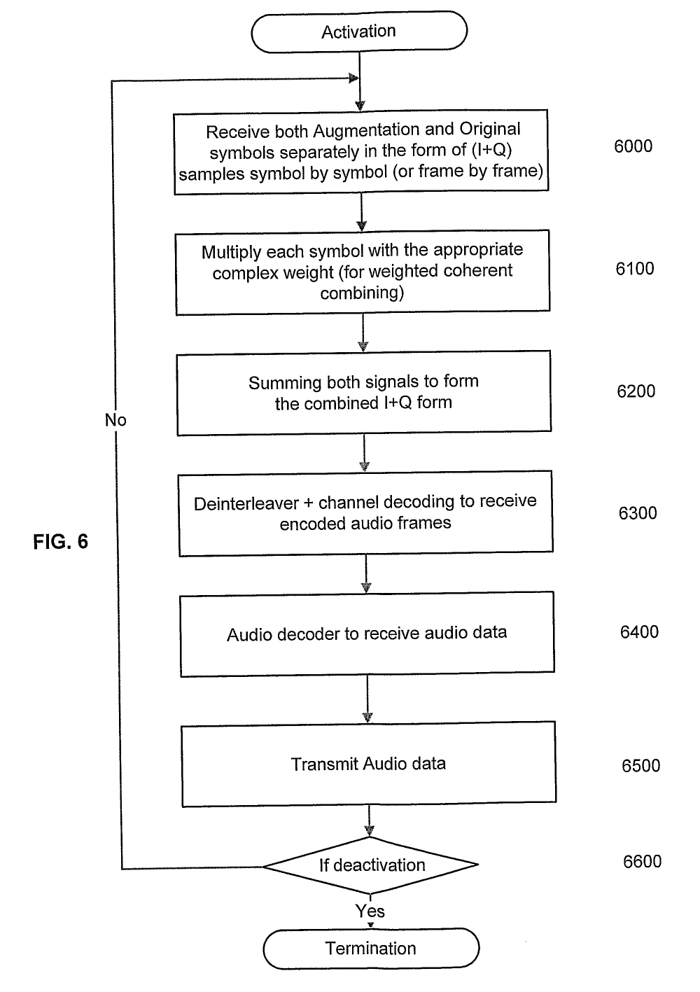

FIGS. 2 through 5 and the text which describes these figures give specific examples of methods by which a communication augmentation signal may be derived from a communication signal received at the supplemental receiver 200. FIGS. 6 through 8 and the text which describes these figures give specific examples of methods by which a communication augmentation signal may be used by a communication device 100 to enhance reception of a communication signal received by receiver circuitry 110 at the communication device 100. According to some embodiment of the present invention, steps for deriving data for a communication augmentation signal may be performed by signal characterization circuitry 215. Steps for using data from a communication augmentation signal to enhance signal reception may be performed by augmentation signal processing circuitry 115. It should be understood by one of skill in the art that the specific circuitry and processes described in FIGS. 1 through 8 are only examples of specific embodiments of the present invention. The present invention may be implemented using a very large variety of circuits and processes not described in the present application, as describing each and every possible circuit and method for collaborative communication signal processing over a multi-function data-link is not practical. It should also be understood by one of ordinary skill in the art that any circuitry and processes suitable for collaborative communication signal processing, known today or to be devised in the future, may be applicable to the present invention.

Turning now to FIG. 2, there is shown a flow chart including the steps of an exemplary method of the frame by frame handling process which may be executed by a supplemental receiver according to some embodiments of the present invention. As shown in FIG. 2, a received communication signal may be processed to get the quantized base band complex symbol termed as I+Q from hereafter (step: 2000). After which the supplemental receiver may build a frame consisting of a vector of I+Q symbols, the frame building may be with accordance to the used MAC+PHY protocols (step: 2100). After which the supplemental receiver may have a cyclic frame queue holding the N most updated frames, this queue if exist is updated with the new coming frame (step: 2200). After which the supplemental receiver may decide whether to send frames to the communication device, the delivery of frames may have selective mode of operation where frames are delivered only when indicated by the communication device which may use the control channel for that, or may have a common rule whether to deliver or not all received frames (step: 2300). A frame which needs to be forward may be copied to a frame transmission queue which may be transmitted to the communication device in an asynchrony manner (step: 2400). After which the supplemental receiver may quit this process or repeat it, this decision may be with accordance to control information received from the external communication device or other internal reasons such as low battery power (step: 2500).

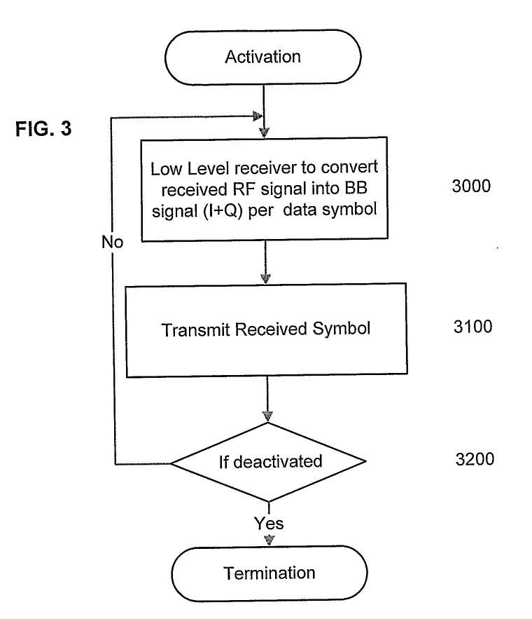

Turning now to FIG. 3, there is shown a flow chart including the steps of an exemplary method of the symbol by symbol handling process which may be executed by a supplemental receiver according to some embodiments of the present invention. As shown in FIG. 3, a received communication signal may be processed to get the quantized I+Q symbol (step: 3000). After which the supplemental receiver may send the received symbol to the communication device (step: 3100). After which the supplemental receiver may quit this process or repeat it, this decision may be with accordance to control information received from the external communication device or other internal reasons such as low battery power (step: 3200).

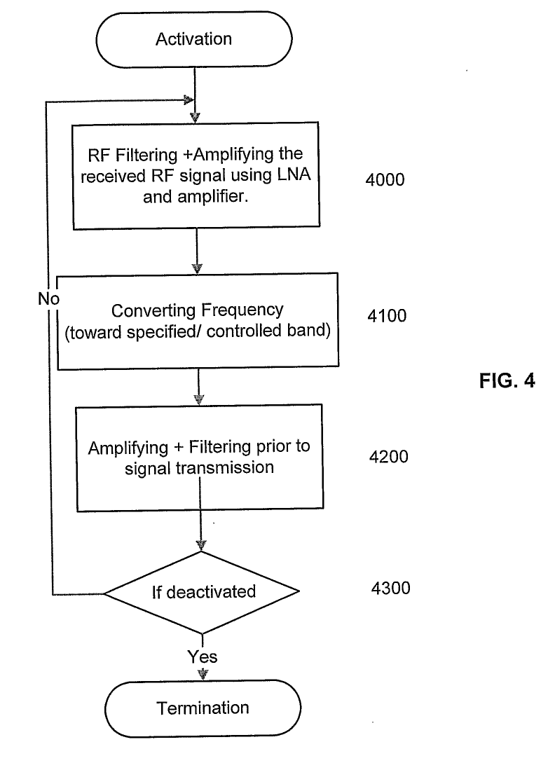

Turning now to FIG. 4, there is shown a flow chart including the steps of an exemplary method of the repeater process which may be executed by a supplemental receiver according to some embodiments of the present invention. As shown in FIG. 4, a received communication signal may be filtered and amplified using low noise amplifier (LNA) (step: 4000). After which the supplemental receiver may convert the frequency band of the signal (step: 4100). After which the supplemental receiver may amplify and transmit the signal toward the communication device (step: 4200). This continuous operation may be terminated at any time with accordance to control information received from the external communication device or other internal reasons such as low battery power, or the purpose of clarity only is placed at the end of the diagram (step: 4300).

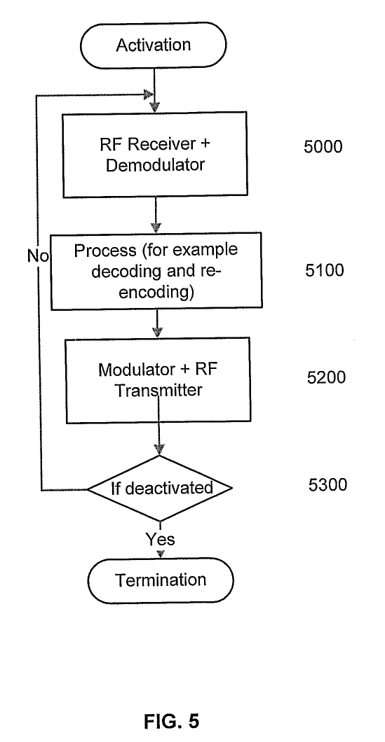

Turning now to FIG. 5, there is shown a flow chart including the steps of an exemplary method of the regenerated repeater process which may be executed by a supplemental receiver according to some embodiments of the present invention. As shown in FIG. 5, a received communication signal may be detected and demodulated (step: 5000). After which the supplemental receiver may process the demodulated signal, for example hard decision of the estimated transmitted signal or may perform channel decoding and re-encoding (step: 5100). After which the supplemental receiver may modulate and transmit the signal toward the communication device (step: 5200). After which the supplemental receiver may quit this process or repeat, this decision may be with accordance to control information received from the external communication device or other internal reasons such as low battery power (step: 5300).

Turning now to FIG. 6, there is shown a flow chart including the steps of an exemplary method of the maximum ratio combining process which may be executed by a communication device according to some embodiments of the present invention. As shown in FIG. 6, two received communication signals (one from the supplemental device and one received at the communication device itself) may be received and synchronized, they may be received as I+Q symbols (whether they received on a symbol by symbol basis or frame by frame basis) (step: 6000). After which the communication device may coherently combine both symbols by multiply each with the relevant conjugate channel response (steps: 6100 and 6200). After which the communication device may de-interleave and decode the channel correcting code if exist (step: 6300). After which the communication device may decode the received data using audio decoder (step: 6400). After which the communication device may transmit the received audio data to the supplemental receiver which may feed its speaker (step: 6500). After which the communication device may quit this process or repeat it (step: 6600).

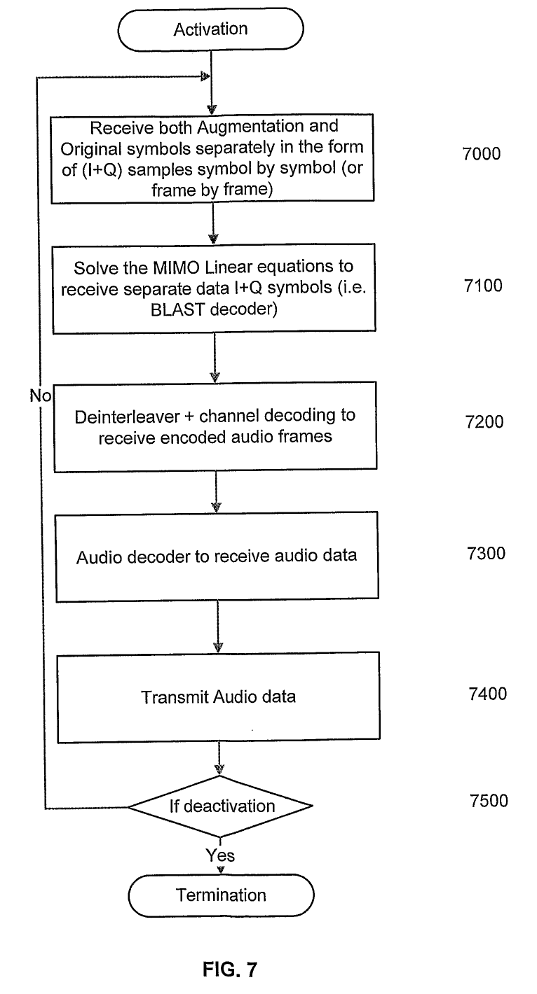

Turning now to FIG. 7, there is shown a flow chart including the steps of an exemplary method of the spatial de-multiplexing process which may be executed by a communication device according to some embodiments of the present invention. As shown in FIG. 7, two received communication signals (one from the supplemental device and one received at the communication device itself) may be received and synchronized, they may be received as I+Q symbols (whether they received on a symbol by symbol basis or frame by frame basis) (step: 7000). After which the communication device may solve the linear equations of this MIMO channel by diagonalizing the square matrix (2×2) of the channel responses to receive two I+Q demultiplexed symbols (step: 7100). After which the communication device may de-interleave and decode the channel correcting code if exist (step: 7200). After which the communication device may decode the received data using audio decoder (step: 7300). After which the communication device may transmit the received audio data to the supplemental receiver which may feed its speaker (step: 7400). After which the communication device may quit this process or repeat it (step: 7500).

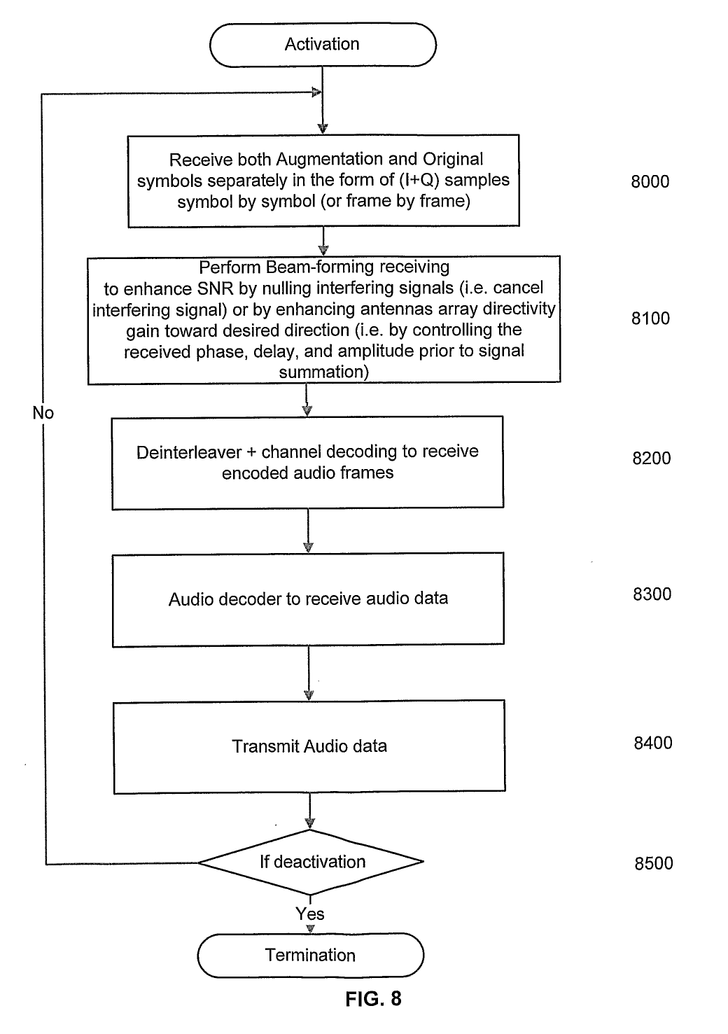

Turning now to FIG. 8, there is shown a flow chart including the steps of an exemplary method of beam forming which may be executed by a communication device according to some embodiments of the present invention. As shown in FIG. 8, two received communication signals (one from the supplemental device and one received at the communication device itself) may be received and synchronized, they may be received as I+Q symbols (whether they received on a symbol by symbol basis or frame by frame basis) (step: 8000). After which the communication device may combine both signals in a way that enhance the signal to noise ratio by blocking interfering signals and increasing signal strength, this is done by multiplying received symbols with a complex matrix (step: 8100). After which the communication device may de-interleave and decode the channel correcting code if exist (step: 8200). After which the communication device may decode the received data using audio decoder (step: 8300). After which the communication device may transmit the received audio data to the supplemental receiver which may feed its speaker (step: 8400). After which the communication device may quit this process or repeat it (step: 8500).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A supplemental receiver for a communication device, said receiver comprising:
first receiver circuitry adapted to receive a communication signal intended for the communication device;
first transmitter circuitry adapted to transmit to the communication device an augmentation signal derived from the communication signal received by the first receiver circuitry; and
second receiver circuitry adapted to receive a signal including audio content from the communication device.

2. The receiver according to claim 1, further comprising a speaker.

3. The receiver according to claim 2, further comprising a microphone and wherein said first transmitter circuitry is further adapted to transmit a signal including audio content to the communication device.

4. The receiver according to claim 1, wherein said second receiver circuitry is adapted to receive from the communication device control signaling for said first receiver circuitry.

5. The receiver according to claim 4, wherein the first transmitter circuitry is adapted to transmit an augmentation signal suitable for diversity reception processing.

6. The receiver according to claim 4, wherein the first transmitter circuitry is adapted to transmit an augmentation signal suitable for beam forming processing.

7. The receiver according to claim 4, wherein the first transmitter circuitry is adapted to transmit an augmentation signal suitable for spatial de-multiplexing processing.

8. The receiver according to claim 4, wherein the first transmitter circuitry is adapted to act as a repeater for the received communication signal.

9. A mobile communication device comprising:
receiver circuitry adapted to receive a communication augmentation signal from a supplemental receiver; and
transmitter circuitry adapted to transmit a signal including audio content to the supplemental receiver.

10. The device according to claim 9, wherein said receive circuitry is adapted to receive from the supplemental receiver a signal including audio content originated in proximity with the supplemental receiver.

11. The device according to claim 9, wherein said transmitter circuitry is further adapted to transmit control signaling to the supplemental receiver.

12. The device according to claim 11, wherein said receiver circuitry is adapted to receive a communication augmentation signal suitable for diversity reception processing.

13. The device according to claim 12, further including communication signal processing circuitry adapted to perform diversity reception processing.

14. The device according to claim 11, wherein said receiver circuitry is adapted to receive a communication augmentation signal suitable for beam forming processing.

15. The device according to claim 14, further including communication signal processing circuitry adapted to perform beam forming processing.

16. The device according to claim 11, wherein said receiver circuitry is adapted to receive a communication augmentation signal suitable for spatial de-multiplexing processing.

17. The device according to claim 16, further including communication signal processing circuitry adapted to perform spatial de-multiplexing processing.

18. The device according to claim 11, wherein said receiver circuitry is adapted to receive a communication augmentation signal adapted for repeater based signal processing.

19. The device according to claim 18, further including communication signal processing circuitry adapted to perform repeater based processing.

20. A communication system comprising:
a supplemental receiver and a communication device, wherein said supplemental receiver is adapted to transmit to the communication device a communication augmentation signal, and wherein the communication device is adapted to transmit to said supplemental receiver a signal including audio content.

21. A method of receiving a communication signal comprising:
transmitting from a supplemental receiver to a communication device a communication augmentation signal; and
transmitting from the communication device to the supplemental receiver a signal including audio content.
